(19) United States
(12) Patent Application Publication
(10) Pub. No.: US 2009/0266310 A1
(43) Pub. Date: Oct. 29, 2009

(54) KIT FOR PROTECTING DOG LEG

(76) Inventor: Richard H. Behme, Syracuse, NY (US)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 12/501,207

(22) Filed: Jul. 10, 2009

Related U.S. Application Data
(63) Continuation of application No. 11/269,072, filed on Nov. 8, 2005.
(60) Provisional application No. 60/723,635, filed on Oct. 4, 2005.

(51) Int. Cl. A01K 13/00

(52) U.S. Cl. 119/850

(57) ABSTRACT

A low cost kit for protecting a dog leg includes in one embodiment a sleeve and a plurality of straps, each having an inner surface, an outer surface, an anchor end and a distal end. Adhesive is disposed at the inner surface of the anchor end, and microfasteners are applied at both the outer surface of the anchor end at the inner surface of the distal end. For manufacturing of a custom dog boot, the straps are retained in a position separate and detached from the sleeve until such time that the sleeve is fitted on a dog leg, and thereafter, attached straps are anchored in position on the sleeve that are guided by the particular size and shape of dog leg being protected.

### CROSS-REFERENCE TO RELATED APPLICATIONS

This application is a continuation of U.S. patent application Ser. No. 11/269,072 filed Nov. 8, 2005 entitled “Kit For Protecting Dog Leg” which claims priority under 35 U.S.C. §119 of Provisional Application No. 60/723,635, filed Oct. 4, 2005 entitled “Kit For Protecting Dog Leg.” The priorities of all of the above applications are claimed and the disclosure of each of the above applications is incorporated herein by reference in its entirety.

### FIELD OF THE INVENTION

The present invention relates in general to safety aids for animals and particularly to a protective dog boot.

### BACKGROUND OF THE INVENTION

Canines (dogs) and similar animals are prone to injury. Dogs commonly suffer injuries to their legs. Dogs commonly incur injuries to their legs while running or walking outdoors, wherein they commonly encounter sharp objects such as broken glass, thorny vegetation, sticks, rocks and pebbles. Dogs also incur injuries to their legs by accidents involving motor vehicles and falling objects.

Heat is a threat to dog safety. The sensitive paw area of a dog leg commonly becomes burned when a dog walks on hot pavement exceeding temperatures of 120 degrees F.

In addition to suffering wounds, such as from a sharp object or heat, dogs often suffer leg breaks. Especially active dogs commonly suffer leg breaks when hunting or running or when engaged in play with other dogs. Sport dogs commonly suffer leg breaks from traps intended for trapping animals other than a dog. Leg breaks can occurs when a dog leg becomes trapped in a hole dug by a burrowing animal, or in other crevices such as those found in pens, fences, and doors. Dogs are also susceptible to injuries from exposure to chemicals, i.e., salt and calcium chloride.

Dog legs are sometimes also subject to routine surgical operations. For example, certain breeds of dogs are commonly subjected to a declawing process wherein claws of a dog's paw are removed. Dogs are also commonly subject to surgical procedures for treatment of ripped nails, ripped paws, tumor removal, claw removal, masses, abscesses, and cancers.

When a dog leg becomes injured or is operated on it is typical to treat the injured or operated on area. For example, a wound at a dog leg may be treated and then wrapped with clean gauze. When a dog leg becomes broken the dog leg must be set in a cast until the broken bone or bones heal. It is important to keep the treated area of a dog leg clean and dry. If a treated area of a dog leg is not kept clean and dry, it can easily become further perturbed and infected.

Proposals have been made in the past to protect dog legs such as dog legs that have been treated for injury. However, these proposals have not satisfactorily addressed major problems associated with protecting a dog leg.

### SUMMARY OF THE INVENTION

According to its major aspects and broadly stated the invention relates in one aspect to a kit for protecting a dog leg. The kit includes a substantially cylindrical sleeve and a plurality of straps. Each strap has an outer surface, an inner surface, an anchor end and a distal end. Adhesive is disposed at the inner surface of the anchor end for anchoring of the strap on the sleeve. Microhooks are disposed on the outer surface of the anchor end and microloops are disposed on the inner surface of the strap at the distal end thereof. Accordingly, when the strap is anchored by pressing the inner surface of the adhesive equipped anchor end onto the sleeve, the microhooks are exposed so that the strap distal end can be wrapped about the sleeve and fastened to the anchor end by mating of the microhooks and microloops. While the straps are specifically constructed to be readily attached to the sleeve, the kit is provided in a form such that the straps are maintained at a location detached from a sleeve until such time that a sleeve is fitted over a dog leg. By withholding anchoring of the straps until such time that the sleeve is fitted over a dog leg, the straps can be anchored in such position and orientation as is best suited for the particular size and shape of dog leg being protected.

In another aspect, the invention relates to a method for manufacturing a custom dog boot. According to a method for manufacturing a custom dog boot a sleeve is provided together with a plurality of straps. Each strap has an outer surface, an inner surface, an anchor end and a distal end. Adhesive is disposed at the inner surface of the anchor end for anchoring of the strap on the sleeve. Microhooks are disposed on the outer surface of the anchor end and microloops are disposed on the inner surface of the strap at the distal end thereof. The sleeve, without straps attached, is fitted over a dog leg; and then, only after fitting of a sleeve over the dog leg, the straps are anchored onto the sleeve and mated to impart a clamping force about the sleeve. A resulting completed dog boot includes a sleeve and straps anchored thereon at such positions that are particularly suited for the particular size and shape of dog leg being protected. The completed dog boot may be removed and reattached to a dog leg several times, to allow re-dressing or cleaning of a treated area during the course of time that a dog recovers from an injury or medical procedure.

These and other aspects of the invention will become apparent from the detailed description of the preferred embodiment herein below.

### BRIEF DESCRIPTION OF THE DRAWINGS

For a further understanding of these and other objects of the invention, reference will be made to the following detailed description of the invention which is to be read in connection with the accompanying drawing, where:

FIG. 1 is a layout diagram of a kit according to the invention including a perspective view of a sleeve; and perspective views of straps according to the invention

FIGS. 2a-2c illustrate a method of manufacturing a dog boot according to the invention

FIG. 2d is a perspective view of a completed dog boot according to the invention having straps fixedly attached thereto in such positions that are suitable for the particular sized and shaped dog leg being protected

FIG. 2e is a perspective view of a completed dog boot manufactured by attaching kit materials to a dog leg different in size and shape from the dog leg of FIGS. 2a-2c.

FIG. 2f is a perspective view of a strap according to the invention in an alternative embodiment, having microloops disposed at an anchor end of the strap and microhooks at distal end of the straps.

FIG. 3 is a construction detail diagram showing an exploded assembly perspective view of a sleeve according to the invention wherein a first sleeve section and a second sleeve section are attached together along their peripheral edges using a heat sealing process and wherein an exploded surface view is included to indicate that microloops can be distributed substantially throughout an entire outer surface of a sleeve. Microhooks can be disposed substantially throughout an area of an entire outer surface of a sleeve rather than microloops.

FIG. 4 is a perspective view of an assembled sleeve assembled according to the method of FIG. 3 wherein an assembled sleeve includes seams extending lengthwise across the sleeve, and wherein the seams can be utilized to aid a rotational orientation of sleeve during application of the sleeve onto a dog leg.

FIG. 5 is a perspective view of a sleeve according to the invention including two layers.

FIG. 6 is a cross sectional view of the sleeve shown in FIG. 5 taken along line 6-6 of FIG. 5.

FIG. 7 is a perspective view of a sleeve according to the invention having two layers wherein an outer layer of the sleeve extends only partially upward on a sleeve from a sleeve distal end point.

FIG. 8 is a perspective view of a sleeve according to the invention including three layers, each layer extending a full length of the sleeve.

FIG. 9 is a cross sectional view of the three layer sleeve shown in FIG. 8.

FIG. 10 is a prospective view of a three layer sleeve according to the invention, whereas the outer layer extended only partially up the length of the sleeve.

FIG. 11 is a cross sectional view of a sleeve according to the invention having two intermediate layers.

FIG. 12 is a cross sectional view of a sleeve according to the invention having N intermediate layers.

### DETAILED DESCRIPTION OF THE INVENTION

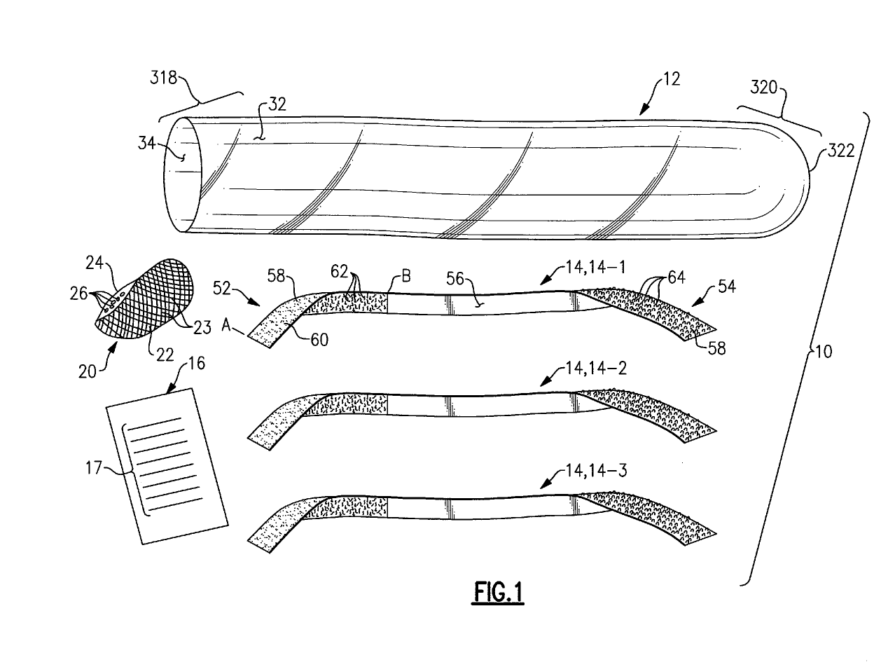

A kit 10 according to the invention is described generally with reference to FIG. 1. Kit 10 includes sleeve 12, sized and shaped to be fitted over a dog leg and a plurality of specifically configured straps 14 as will be described more fully herein. Kit 10 in the illustration embodiment of FIG. 1 comprises at least three specifically configured straps 14. Kit 10 may further include an instruction manual 16 providing basic instructions for use of kit 10. Manual 16 can be a paper manual and can include printed instructions detailing the manner in which sleeve 12 is to be fitted over a dog leg and the manner in which straps 14 are to be affixed to sleeve 12 after sleeve 12 is fitted over a dog leg such that sleeve 12 is securely attached to a dog leg to provide protection. Kit 10 can also include an anti-skid pad 20, the function of which is described in greater detail herein. In the illustrative embodiment of FIG. 1, kit 10 includes three straps 14; namely, straps 14-1, 14-2, and 14-3.

Referring to further aspects of manual 16, manual 16 can also be electronically displayed, e.g., as in an Internet web page that can be displayed on a computer display with use of a browser, or a viewable text file that can be displayed on a computer display and which is stored on a computer readable memory device. In summary, instruction manual 16 can be provided providing any one of:
(1) A paper instruction manual as shown in FIG. 1 including a set of printed instructions for securing a sleeve to a dog leg.
(2) A memory device (a CD, a disk, a PC hard drive, a server hard drive) storing a file (e.g., HTML, WPD) which, when opened by a display equipped computer, results a set of instructions for securing a sleeve to a dog leg being displayed.
(3) Universal Resource Locator (URL) designating an IP address, which when entered into a browser command line prompt, results in a website including a set of instructions (or links to a set of instructions) for securing a sleeve to a dog leg being displayed on a computer display. The instruction manual can be included in an HTML file which is sent to a display equipped client computer for display on the client display on receipt of a get command from the client's browser.

It will be seen that by maintaining a server with an HTML web page encoding the instruction manual and by providing a URL to an end user for access to the HTML web page, an entity may provide both of (2) and (3) above. A URL corresponding to a web page instruction manual can be printed on a package containing one or more components of kit 10.

The instructions 17 of instruction manual 16 can take on a variety of forms. The instructions 17 can include instructions advising a user to maintain straps 14 separate from sleeve 12 until sleeve 12 is applied over a dog leg 18. The instructions 17 can also include the instructions to maintain anti-skid pad 20 separate from sleeve 12 until sleeve 12 is applied over a dog leg 18.

In accordance with the invention, in one aspect, it is expected that kit 10 will be supplied (1) to veterinarians' offices for use by veterinarians in executing medical procedures; (2) to veterinarians offices, wherein veterinarians will provide kit 10 to a dog owner for use in protecting a dog leg after a medical procedure and; (3) to retail stores such as pet shops for resale to dog owner for use in protecting a dog leg 18.

An exemplary set of instructions of an illustrative instruction manual is as follows: (1) While maintaining the straps and the anti-skid pad separate from the sleeve apply the sleeve over a dog leg; (2) cut off excess sleeve portion, (3) anchor and mate straps to clamp sleeve about dog leg; (4) adhere anti skid pad on sleeve under paw.

Referring to further aspects of kit 10, sleeve 12 is preferably comprised of flexible material, such as non-fibrous polyethylene, fibrous polyethylene, latex, fabric and additional materials which are described in greater detail herein. Sleeve 12 is shown in FIG. 1 includes an outer surface 32 and an inner surface 34. Sleeve 12 may have a substantially uniform diameter throughout its length and may be substantially cylindrical in shape. Sleeve 12 can include an open proximal end 318 and a tapered and closed distal end 320 that terminates at a distal end point 322. In the embodiment of FIG. 1 sleeve 12 has a single opening; namely, the opening shown at proximal end 318. Sleeve 12 can be sized and shaped to be large enough to fit over the leg of a larger size breed of dog such as a German Shepard, Siberian Husky, Boxer, Great Dane, Greyhound, Labrador, Rottweiler, St. Bernard, yet small enough to be fitted over the leg of a small dog such as a Toy Poodle, Terrier, Beagle and the like. Where sleeve 12 is sized to be fitted over the leg of a large breed of dog, sleeve 12 can be expected to be applied over a leg of any size dog. Dimensions for sleeve 12 in one embodiment are 30 inches in length by 6 inches in diameter. Sleeve 12 can also have a smaller diameter such as 2 inches. While sleeve 12 in some embodiments is breathable and water permeable, sleeve 12 in one embodiment is of sealed construction such that air and water or other liquid cannot readily enter into the interior sleeve from outer surface 32 of sleeve 12. The term “sealed” herein covers both perfectly sealed structures (i.e., no fluid entry) and structures which through deviating from a perfect seal substantially prevent fluid entry.

Referring to further aspects of straps 14, straps 14 of kit 10 are preferably of specific construction. A kit 10 can have one strap or more than one strap. In the embodiment of FIG. 1, kit 10 includes three straps; namely first strap 14-1, second strap 14-2 and third strap 14-3. Referring to FIG. 1 each strap 14 includes an anchor or proximal end 52 and a distal end 54. As will be described further herein, anchor end 52 is adapted to be anchored onto sleeve 12 after sleeve 12 is fitted over a dog leg. Each strap 14 may be between about 12 inches and about 24 inches in length to ensure that strap 14 can be encircled about sleeve 12 after sleeve 12 is fitted over a dog leg. Referring to specific attributes of strap 14, strap 14 includes outer surface 56 and inner surface 58. At proximal or anchor end 52, strap 14 has disposed thereon adhesive material designated generally by reference element 60. When adhesive material 60 is applied to inner surface 58 of anchor end 52 such that when anchor end 52 is pressed onto a surface configured to receive the adhesive equipped anchor end (e.g., outer surface 32 of sleeve 12) strap 14 is firmly secured to surface 32. Referring to further aspects of sleeve 12, inner surface 58 at distal end 54 of sleeve 12 has disposed thereon microloops designated by the reference numeral 62. Referring to further aspects of strap 14, an outer surface 56 of strap 14 comprises microhooks designated by reference numeral 62. Microhooks 62 may be disposed throughout the length of anchor end 52 of strap 14 at outer surface 56 thereof. It is seen that, according to the invention, strap 14 can be anchored onto sleeve 32 by pressing inner surface 58 of anchor end 52 onto sleeve then wrapping distal end 54 about a dog's leg one or a plurality of times prior to fastening microloops 64 onto associated microhooks 62 of strap 14.

Microhooks 62 and microloops 64 can be provided by VELCRO brand microfasteners of the type available from VELCRO INDUSTRIES, BV. The mating pair of microfasteners bearing structures (e.g., anchor end 52 and distal end 54) can be regarded as detachably mating structures since the mating force that attaches the structures together is not substantially degraded (i.e., remains substantially the same) when the structures are detached from one another and reengaged. By contrast, when and if “non-detachably engaged” adhesive backed inner surface 58 of anchor end 52 is detached from sleeve 12, the mating force that attaches anchor end 52 to sleeve 12 when re-mated would be substantially degraded relative to the mating force attaching anchor end 52 and sleeve 12 when attached a first time. In general, the mating force mating strap 14 to sleeve 12 when strap is anchored to sleeve a first time is greater than a mating force supplied by microfasteners 62, 64 mating distal end 54 and anchor end 52.

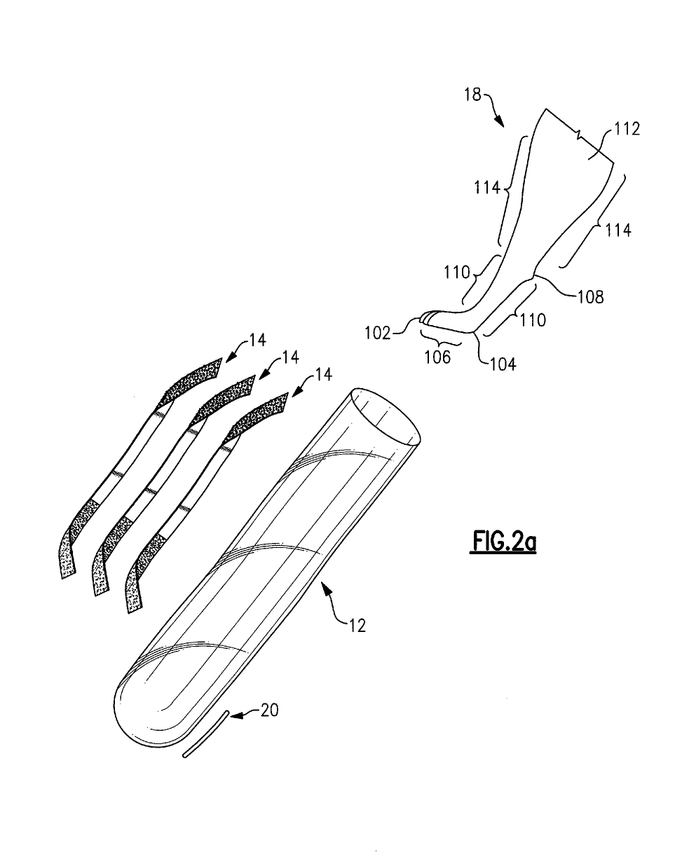

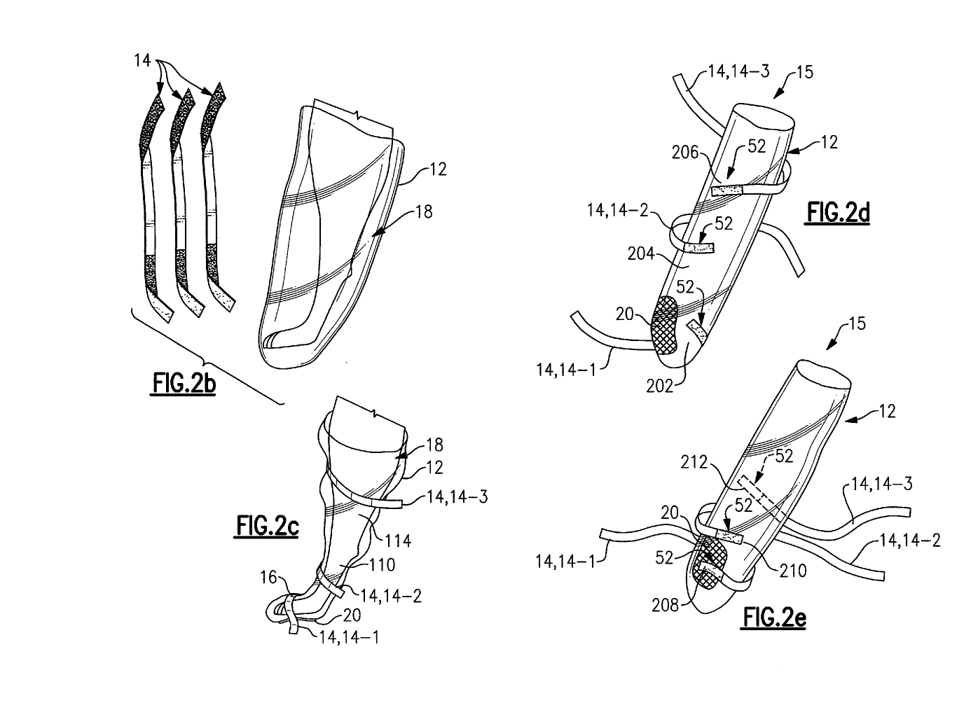

Referring to further aspects of strap 14, anchor end 52 of strap 14 can be regarded as extending from position A to position B as indicated in FIG. 1 while distal end 54 of strap 14 can be regarded as extending from position B to position C of strap 14. In one example of the invention, anchor end 52 can have a length of between about 1 inch and about 6 inches while distal end 54 can have a length from about 4 inches to about 15 inches. In the embodiment shown in FIG. 1, anchor end 52 and distal end 54 border one another (i.e., the distal end begins where the anchor end terminates). Adhesive 60 can be disposed substantially throughout the length of anchor end on inner surface 58 and microhooks 62 can be disposed substantially throughout the length of anchor end 52 on outer surface 56. Microloops 62 can be disposed substantially throughout the length of distal end 54 on inner surface 58 of strap 14. Straps 14 can be constructed utilizing commercially available stock parts. For example, in the embodiment of FIG. 1, anchor end 52 and distal end 54 are commercially available stock parts that can be sewn or adhered together to form strap 14. Anchor end 52 having adhesive inner surface and microhook outer surface can be provided by a part known as an adhesive backed microhook strip. Distal end 54 can be provided by a part known as a microloop strip. The adhesive backed microhook strip and microloop strip can be fastened together; e.g., by sewing the strips together to make strap 14 or by adhering the strips together with use of glue or epoxy or by heat sealing the strips together. In the embodiment of FIG. 1, microhooks 62 are disposed at the outer surface of anchor end 52 and microloops 64 are disposed throughout inner surface of strap at distal end 54. It will be understood that the relationship between the microhook and microloop microfasteners can be inverted; that is, as indicated in the view of FIG. 2f, microloops 64 can be disposed substantially throughout the length of anchor end 52 at outer surface 56 and microhooks 62 can be disposed substantially throughout the length of distal end 54 and inner surface 58.

While a particular embodiment has been described, kit 10 can be provided in many alternative models so that the user preferences are satisfied and so that a best fit kit is available to a dog no matter the dog size. Table A summarizes construction details of several models of a kit 10 that may be made available according to the invention.

TABLE A

| | Sleeve | Strap | | |
|---|---|---|---|---|
| Model No. | Dimensions | Dimensions | Anchor End | Distal End |
| 1 | 30″ length × | 9″ length × | VELCRO ® Brand Hook | VELCRO ® Brand Loop 1000 |
| | 2″ diameter | ½″ wide | 88 ½″ (12.7 MM) White | ½″ (12.7 MM) White 010 |
| | | | 010 PSA 0172 | Sew-On 0199 |
| 2 | 30″ length × | 13″ length × | VELCRO ® Brand Hook | VELCRO ® Brand Loop 1000 |
| | 3″ diameter | ½″ wide | 88 ½″ (12.7 MM) White | ½″ (12.7 MM) White 010 |
| | | | 010 PSA 0172 | Sew-On 0199 |
| 3 | 30″ length × | 17″ length × | VELCRO ® Brand Hook | VELCRO ® Brand Loop 1000 |
| | 4″ diameter | ½″ wide | 88 ½″ (12.7 MM) White | ½″ (12.7 MM) White 010 |
| | | | 010 PSA 0172 | Sew-On 0199 |
| 4 | 30″ length × | 20″ length × | VELCRO ® Brand Hook | VELCRO ® Brand Loop 1000 |
| | 5″ diameter | ½″ wide | 88 ½″ (12.7 MM) White | ½″ (12.7 MM) White 010 |
| | | | 010 PSA 0172 | Sew-On 0199 |
| 5 | 30″ length × | 24″ length × | VELCRO ® Brand Hook | VELCRO ® Brand Loop 1000 |
| | 6″ diameter | ½″ wide | 88 ½″ (12.7 MM) White | ½″ (12.7 MM) White 010 |
| | | | 010 PSA 0172 | Sew-On 0199 |
| 6 | 30″ length × | 9″ length × | VELCRO ® Brand Hook | VELCRO ® Brand Loop 1000 |
| | 2″ diameter | ¾″ wide | 88 ¾″ (19.05 MM) White | ¾″ (19.05 MM) White 010 |
| | | | 010 PSA 0172 | Sew-On 0199 |
| 7 | 30″ length × | 13″ length × | VELCRO ® Brand Hook | VELCRO ® Brand Loop 1000 |
| | 3″ diameter | ¾″ wide | 88 ¾″ (19.05 MM) White | ¾″ (19.05 MM) White 010 |
| | | | 010 PSA 0172 | Sew-On 0199 |
| 8 | 30″ length × | 17″ length × | VELCRO ® Brand Hook | VELCRO ® Brand Loop 1000 |
| | 4″ diameter | ¾″ wide | 88 ¾″ (19.05 MM) White | ¾″ (19.05 MM) White 010 |
| | | | 010 PSA 0172 | Sew-On 0199 |
| 9 | 30″ length × | 20″ length × | VELCRO ® Brand Hook | VELCRO ® Brand Loop 1000 |
| | 5″ diameter | ¾″ wide | 88 ¾″ (19.05 MM) White | ¾″ (19.05 MM) White 010 |
| | | | 010 PSA 0172 | Sew-On 0199 |
| 10 | 30″ length × | 24″ length × | VELCRO ® Brand Hook | VELCRO ® Brand Loop 1000 |
| | 6″ diameter | ¾″ wide | 88 ¾″ (19.05 MM) White | ¾″ (19.05 MM) White 010 |
| | | | 010 PSA 0172 | Sew-On 0199 |
| 11 | 30″ length × | 9″ length × | VELCRO ® Brand Hook | VELCRO ® Brand Loop 1000 |
| | 2″ diameter | 1″ wide | 88 1″ (25.4 MM) White | 1″ (25.4 MM) White 010 |
| | | | 010 PSA 0172 | Sew-On 0199 |
| 12 | 30″ length × | 13″ length × | VELCRO ® Brand Hook | VELCRO ® Brand Loop 1000 |
| | 3″ diameter | 1″ wide | 88 1″ (25.4 MM) White | 1″ (25.4 MM) White 010 |
| | | | 010 PSA 0172 | Sew-On 0199 |
| 13 | 30″ length × | 17″ length × | VELCRO ® Brand Hook | VELCRO ® Brand Loop 1000 |
| | 4″ diameter | 1″ wide | 88 1″ (25.4 MM) White | 1″ (25.4 MM) White 010 |
| | | | 010 PSA 0172 | Sew-On 0199 |
| 14 | 30″ length × | 20″ length × | VELCRO ® Brand Hook | VELCRO ® Brand Loop 1000 |
| | 5″ diameter | 1″ wide | 88 1″ (25.4 MM) White | 1″ (25.4 MM) White 010 |
| | | | 010 PSA 0172 | Sew-On 0199 |
| 15 | 30″ length × | 24″ length × | VELCRO ® Brand Hook | VELCRO ® Brand Loop 1000 |
| | 6″ diameter | 1″ wide | 88 1″ (25.4 MM) White | 1″ (25.4 MM) White 010 |
| | | | 010 PSA 0172 | Sew-On 0199 |
| 16 | 30″ length × | 9″ length × | Anchor End Provided By | Distal End Inner Surface Has |
| | 2″ diameter | ½″ wide | Adhesive Backed | Microhooks Disposed Thereon |
| | | | Microloop Section | |
| 17 | 30″ length × | 13″ length × | Anchor End Provided By | Distal End Inner Surface Has |
| | 3″ diameter | ½″ wide | Adhesive Backed | Microhooks Disposed Thereon |
| | | | Microloop Section | |
| 18 | 30″ length × | 17″ length × | Anchor End Provided By | Distal End Inner Surface Has |
| | 4″ diameter | ½″ wide | Adhesive Backed | Microhooks Disposed Thereon |
| | | | Microloop Section | |
| 19 | 30″ length × | 20″ length × | Anchor End Provided By | Distal End Inner Surface Has |
| | 5″ diameter | ½″ wide | Adhesive Backed | Microhooks Disposed Thereon |
| | | | Microloop Section | |
| 20 | 30″ length × | 24″ length × | Anchor End Provided By | Distal End Inner Surface Has |
| | 6″ diameter | ½″ wide | Adhesive Backed | Microhooks Disposed Thereon |
| | | | Microloop Section | |

In the embodiments summarized in Table A, straps 14 have substantially fixed non-variable lengths. However, straps 14 can also be configured to be stretchable so that straps 14 have variable lengths. Making straps 14 from stretchable elastic or latex can increase comfort for a dog. Models of kit 10 can be provided having the parameters indicated in Table A, except with the straps by stretchable structures having maximum (stretched out) lengths as indicated by the strap length summarized in Table A.

Further aspects of the invention are described with reference to FIGS. 2a through 2e wherein attachment and detachment processes according to the invention are described. It will be seen that the fitting and securing process detailed relative to FIGS. 2a-2e also describes a method for manufacturing a custom dog boot customized to satisfy the requirements of a particular dog. Referring to FIG. 2a, protective sleeve 12 is shown in position relative to dog leg 18. Prior to fitting of sleeve 12 on leg 18, it is seen that straps 14 are in a state such that they are not anchored or otherwise attached to sleeve 12. Rather, each of three straps 14 is in a detached state and is movable and maneuverable relative to sleeve 12.

Referring to dog leg 18, dog leg 18 is regarded as being made up of numerous anatomical parts. Specifically, dog leg 18 includes forefoot 102 and hind foot 104. Forefoot 102 and hind foot 102 delimit paw 106. With further reference to dog leg 18, dog leg 18 includes carpals or wrist 108 which together with hind foot 104 delimits lower leg 110. Dog leg 18 further comprises a shoulder 112 which together with carpals 108 delimit upper leg 114. The rear portion of lower leg 110 is regarded as a pastern while the forward portion of leg 114 is regarded as the forearms.

The providing of straps 14 in a form such that straps 14 remain separate and detached from sleeve 12 prior to a time that sleeve 12 is fitted over leg 18 yields numerous advantages. One advantage is that by withholding the anchoring of straps 14 onto sleeve 12 until the time that sleeve 12 is fitted over leg 18, straps 14 can be spaced and positioned on leg 18 in such positions as are suitable for the specific size and shape of leg 18 onto which sleeve 12 is being fitted. By contrast, where straps 14 are anchored on sleeve 12 prior to sleeve 12 being fitted onto leg 18 a first time it is possible that straps 14 can be positioned in undesirable positions owing to peculiarities in a particular dog leg being protected. For example, where straps 14 are anchored on sleeve 12 prior to sleeve 12 being fitted onto leg 18 a first time, the straps may be undesirably positioned in such position that they impart pressure on a joint or on a wound so as to cause discomfort to a dog and/or to limit a dog's mobility.

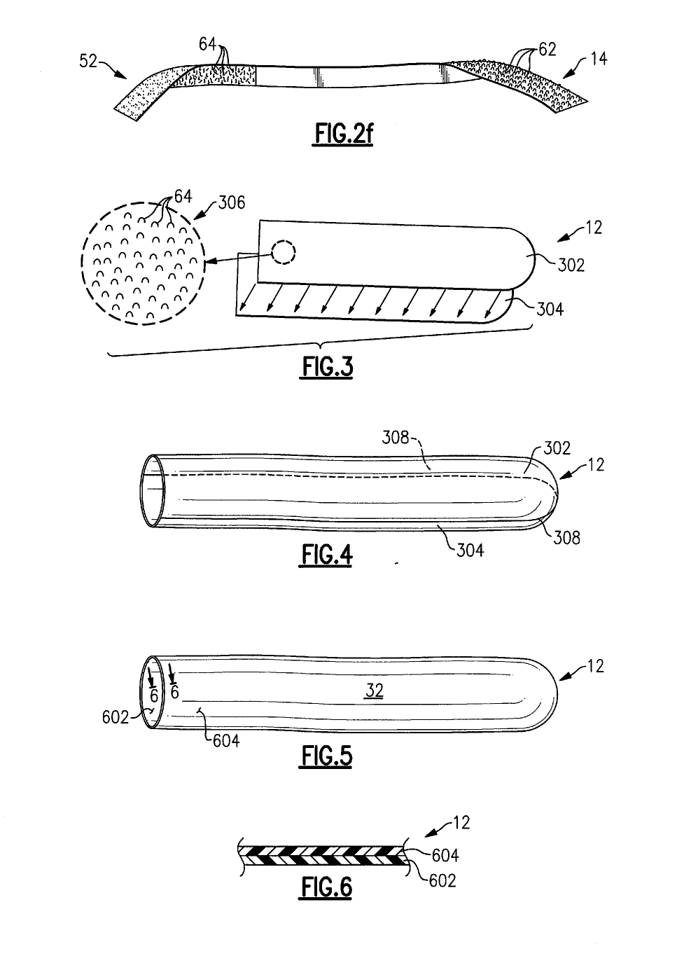

Referring to FIG. 2b, a first step of a method for securing a sleeve 12 to a dog leg 18 and a first step of a method for manufacturing a custom configured dog boot is illustrated. Referring to FIG. 3b, a first step of securing a sleeve 12 to a dog leg 18 and a first step of manufacturing a custom configured dog boot is to fit the sleeve 12 over a dog leg 18 while maintaining the one or more straps 14 of kit 10 separate and detached from the sleeve. Sleeve 12 is shown as being fitted over dog leg 18. It is seen in FIG. 2b that when sleeve 12 is initially applied over a dog leg 18 straps 14 remain in a position such that straps 14 are detached from sleeve 12. After sleeve 12 is applied to dog leg 18 such that paw 106 extends to distal end 320 of sleeve 12, there can be expected to be an excess portion of the sleeve bunched up in the area of shoulder 18 where the dog leg 18 is shorter than sleeve 12. Accordingly a second step of a method for securing sleeve 12 and for manufacturing a custom configured dog boot is to cut excess material at a proximal end 318 of sleeve 12.

Referring now to FIG. 2c, a third step of a process for securing sleeve 12 to dog leg 18 and for manufacturing a dog boot is described. According to a third step for securing sleeve 12 and manufacturing a custom configured dog boot, the one or more straps 14 of kit 10 are anchored to sleeve 12 then mated to clamp sleeve 12 about leg 18. With further reference to FIG. 2c, sleeve 12 is shown as being fitted onto dog leg 18 with straps 14 being anchored onto sleeve 12. In a process for securing sleeve 12 onto leg 18 a first strap 14 can be anchored at its anchor end 52 onto sleeve 12, then wrapped about paw 106 and mated to clamp sleeve 20 about paw 106. Microloops 64 of distal end 54 can be engaged (mated) to microhooks 62 of anchor end 52. It is seen that with the particular construction of strap 14 described, strap 14 can be anchored onto sleeve 12 at any position or orientation. It has been indicated previously that a strap 14 can be anchored onto sleeve 12 by pressing adhesive equipped inner surface 58 of anchor end 52 onto outer surface 32 of sleeve 12. The ability to anchor strap 14 at a position and orientation selected by a user after a user first observes sleeve 12 fitted on a dog's leg provides significant advantages. As has been indicated, straps 14-1, 14-2, 14-3 each can be positioned at a position that is guided or determined by the particular size and shape of a dog leg being protected. In the use case illustrated with reference to FIG. 2c, first strap 14-1 is wrapped about a paw 106, second strap 14-2 is wrapped about a lower leg 110 while strap 14-3 is wrapped about upper leg 114. Each strap 14-1, 14-2, 14-3 when positioned as described on paw 106, lower leg 110, and upper leg 114 is positioned away from a leg joint, i.e., away from the dog ankle between lower leg 110 and paw 106 and away from carpals 108. If clamped about a joint, a strap 14 could cause discomfort to the dog. The ability to anchor straps 14 at any position or orientation about the circumference of sleeve 12 provides advantages in addition to facilitating construction of a dog boot that is custom configured for a particular dog leg. For example, where it is generally desired to apply strap 14-1 to paw 106, but scar tissue of a wound is noted on a dog paw 106 at a particular location of paw 106, the invention allows strap 14-1 to be adaptively anchored to sleeve 12 in a position so that when strap 14-1 is wrapped about paw 106 extensive pressure on the wounded area can be avoided (i.e. if a wound is centered on paw 106 strap 14-1 can be utilized to clamp sleeve 12 at a position slightly off of the centered position so that excessive pressure on the wound is avoided). Similarly, straps 14-2 and strap 14-3 can be positioned on lower leg 110 and upper leg 114 respectively in such positions that clamping pressure on a particularly sensitive area of a dog leg is avoided.

It will be seen that the strap anchoring and mating step of securing a sleeve to a dog leg and of making a custom configured dog boot can be regarded as having a plurality of substeps. Where there is one strap provided, the anchoring and mating step can be regarded as including a first step to anchor the strap and a second step to mate the strap to clamp a sleeve about a dog leg. Where there are two straps provided, the anchoring and mating step can be regarded as including a first step to anchor a first strap to a sleeve proximate a paw, a second step to mate the first strap to impart a clamping force, a third step to anchor the second strap to a sleeve proximate a leg (upper or lower), and a fourth step to mate the second strap to impart a clamping force. Where there are three straps provided, the anchoring and mating step can be regarded as including a first step to anchor a first strap to a sleeve proximate a paw, a second step to mate the first strap to impart a clamping force, a third step to anchor the second strap to a sleeve proximate a leg lower, a fourth step to mate the second strap to impart a clamping force, a fifth step to anchor the third strap to sleeve proximate an upper leg and a sixth step to mate the third strap to impart a clamping force. A strap is typically mated by mating a distal end of the strap to complementary microfasteners of the strap's anchor end. However, as will be explained, a strap can also be mated by a mating strap distal end 54 to a surface of sleeve 12 where the sleeve has microfasteners disposed (distributed) over an area of the sleeve's outer surface or to a combination of a sleeve and a strap anchor end where both the strap anchor end and the sleeve outer surface 32 have complementarily formed microfasteners configured to engage the microfasteners of the strap distal end.

Particularly when suffering from painful injuries, canines can be expected to be lively and restless during the process of fitting and securing sleeve 12 onto dog leg 18. Also, dogs that are suffering from injuries or that are sedated after a medical procedure cannot be expected to move the leg into a position which would facilitate easy installation of sleeve 12 onto leg 18. The present invention addresses both the expected restlessness of a dog and the expected lack of mobility of a dog during the process of securing sleeve 12 to dog leg 18. Specifically, the expected restlessness of a dog is addressed in that the specific construction of strap 14 in combination with the withholding of anchoring of strap 14 until the time that sleeve 12 is fitted over leg 18 enables quick anchoring of each strap 14 onto sleeve 12. Because anchor ends are formed to be quickly adhering and tacky, the anchor ends 52 can be quickly anchored onto sleeve 12 within a matter of seconds. The rapidity of the anchoring process is facilitated not only by the construction of anchor end 52 (in particular the selection of adhesive 60) but by the fact that strap 14 need not be anchored on a predetermined anchor position of sleeve 12 (the care provider need not waste time searching for and positioning strap 14 relative to a predetermined position on which to anchor strap). Rather, strap 14 e.g. strap 14-1 can be anchored on any area of sleeve 12 configured to receive anchor end 52 that happens to be exposed when sleeve 12 is fitted over leg 18.

The particular construction of strap 14 in combination with the withholding of the anchoring of sleeve 12 until the time sleeve 12 is fitted over leg 18 addresses the expected immobility of a dog during the protecting process in that straps 14 can be anchored in any position or orientation about the outer surface of sleeve 12. Accordingly, since strap 14-3 can be anchored in any position on the outer surface 32 of sleeve 12, it would be of no issue that a lack of mobility of a dog prevented strap 14-3 from being anchored from a certain position, e.g. such as a position on outer surface 32 facing inwardly toward an opposite leg of the dog.

Referring now to FIG. 2d, sleeve 12 having straps 14-1, 14-2, 14-3 securely anchored thereon is shown. The combination of sleeve 12 having straps 14-1, 14-2, 14-3 anchored thereon and therefore firmly attached thereto can be regarded as a completed dog boot. Referring to FIG. 2d, FIG. 2d shows sleeve 12 having straps 14-1, 14-2, 14-3 anchored and therefore firmly attached thereto. FIG. 2d shows a combination of sleeve and straps 14 in the state after sleeve 12 is removed from leg 18. The completed dog boot of FIG. 2d is designated with the reference numeral 15. It is noted with reference to FIG. 2d that straps 14-1, 14-2, 14-3 may be anchored in an unsymmetrical pattern. Strap 14-1 in the embodiment of FIG. 2d is anchored at position 202. Anchor end 52 is anchored at a downward extending angle and is oriented so that strap 14-1 is positioned to wrap around sleeve 12 in a clockwise manner. Anchor end 52 of strap 14-2 is anchored at a position 204 at an upward directed angle and is anchored at such position such that strap 14-2 wraps around sleeve 12 in a clockwise manner. Anchor end 52 of strap 14-3 is anchored at position 26 and it extends at an upward directed angle. Strap 14-3 is anchored in such position that strap 14-3 wraps around sleeve in a counter clockwise manner, in a direction opposite strap 14-2 and strap 14-3. Anchoring strap 14-3 in such position that strap 14-3 wraps around sleeve 12 in a direction opposite strap 14-1 provides certain advantages. Specifically, if pulling of an anchored first strap oriented in and extending in a first direction (e.g., clockwise), results in sleeve 12 rotating about leg 18 more than is desired, a second anchored strap extending in a second direction (e.g., counter clockwise) can be pulled in the direction of its orientation to correct the mispositioning that resulted from an over rotation of sleeve 12. Straps 14, adhesive 52 and sleeve surface 32 can be configured so that when straps 14 are anchored on sleeve 12, the straps 14 remain attached to sleeve 12 when a human of average strength applies a moderate pulling force to pull a strap 14 from sleeve 12.

Positions and orientations of straps 14-1, 14-2, 14-3 are the result of the specific requirements of the dog leg to which sleeve 12 has been previously fitted onto and secured. Because straps 14 as shown in FIG. 2a-2e are anchored in positions that are guided by a particular size and shape of a dog leg an aspect of the invention is a custom manufacturing process wherein a dog boot 15 is custom manufactured to fit a particularly sized and shaped dog leg. The custom manufacturing process has been described herein. In summary, a custom manufacturing process according to the invention includes the steps of providing a series of straps in unattached form relative to a sleeve; applying a sleeve over a dog leg while maintaining the strap in unattached relation to the sleeve; cutting away any excess sleeve 12 material, and then fixedly anchoring and mating the straps, respectively, about (1) a paw of a dog, (2) a lower leg of a dog leg and (3) an upper portion of a dog leg to clamp the sleeve about a dog leg. That is, first strap 14-1 is circled about a paw 106 and mated to impart a clamping force about paw 106, a second strap 14-2 is circled about lower leg 110 and mated to impart a clamping force about lower leg 110; while third strap 14-3 is circled about upper leg 114 and mated to impart a clamping force about upper leg 114.

Referring to FIG. 2e an alternative dog boot 15 is shown. The dog boot 15 is constructed by applying sleeve 12 to a dog leg 18 other than the dog leg shown in FIGS. 2a-2u, and therefore has characteristics that differ from the dog boot 15 shown in FIG. 2d. Dog boot 15 of FIG. 2e can be manufactured from the same original kit 10 as shown in FIG. 2a for use in manufacturing boot 15 of FIG. 2d, but since manufactured by applying the ingredients of kit 10 to a different dog leg, straps 14-1, 14-2, 14-3 of dog boot 15 take on different characteristics than those of the dog boot shown in FIG. 2d. Specifically, in the example shown in FIG. 2e, wherein sleeve 12 is applied to a smaller dog leg than the leg shown in FIGS. 2a-2c, straps 14-1, 14-2, 14-3 are spaced closer together than the straps of FIG. 2d. The anchor ends 52 of boot 15′ in the embodiment of FIG. 2e are also in different respective positions 208, 210, 212 and different respective orientations than the anchors of straps 14-1, 14-2, 14-3 shown in the completed boot of FIG. 2d.

Referring to additional aspects of the process of securing sleeve 12 to dog leg 18, anti-skid pad 20 can be, like straps 14, maintained separate from sleeve 12 until such time that sleeve 12 is applied to leg 18. By maintaining anti-skid pad 20 separate from dog leg 18 until such time that sleeve 12 is applied over dog leg 18, it is assured that anti-skid pad 20 is secured to sleeve 12 at such position that is guided by the requirements of the particular dog leg being treated and custom positioned to satisfy the needs of the particular dog leg. Referring to FIG. 2c, anti-skid pad 20 can be applied to sleeve 12 on the area of sleeve 12 that is under paw 106, after sleeve 12 is applied over leg 18. The securing of anti-skid pad 20 can be regarded as a fourth step of a method for securing sleeve 12 to dog leg and for manufacturing a dog boot.

Anti-skid pad 20 includes an outer surface 22 and an inner surface 24. On outer surface 22 there is disposed gritty anti slip material 23, such as a mixture of sand with binder that binds the sand together and binds the sand to outer surface 22. On inner surface 24 there is disposed adhesive 26. Anti-skid pad 20, adhesive 26, and sleeve 12 can be configured so that when anti-skid pad 20 is applied to sleeve 12, anti-skid pad 20 is firmly adhered to sleeve 12 such that anti-skid pad 20 remains attached to sleeve 12 when a human of average strength applies a moderate pulling force to separate pad 20 from sleeve 12. In one illustrative embodiment anti-skid pad 20 is provided by SAFETY-WALK anti-skid pad of the type available from 3M Company. Anti-skid pad 20 can like distal ends 52 of straps 14, be provided with removable thin plastic protective sheets (not shown) which protect the adhesive of pad 20 and anchor end 52 respectively before they are fixedly secured to sleeve 12, and which are removed from pad 210 and anchor end 52, respectively, when it is time to install the respective adhesive equipped kit parts to sleeve 12.

After sleeve 12 is initially fitted onto and then secured to dog leg 18 by clamping the sleeve 12 using straps 14 it can be expected to be beneficial to remove sleeve 12 on a temporary basis to access the treated area of a dog leg. It may be beneficial to access a treated area in order to (a) change a wound dressing to remove dirt or particulated matter from a treated area, (b) to a adjust a cast or a brace, (c) to clean blood accumulated in the treated area, (d) to air out a dog leg for the comfort of a dog, or (e) for any other purpose. In one envisioned use case, sleeve 12 is fitted onto and secured to dog leg 18 when a dog is taken outside on a walk and then is removed when a dog is brought indoors.

A major advantage of the present invention is that the invention facilitates easy removal and re-securing of a sleeve 12 after sleeve 12 has been secured a first time. Completed dog boot 15, having sleeve 12 fixedly anchored straps 14, and anti-skid pad 20 is removed by de-mating (detaching) distal ends 54 of straps from anchor ends 52 to loosen sleeve 12, and then pulling sleeve 12 off of leg 18. When a boot e.g., boot 15 as shown in FIG. 2d is removed from leg 18, boot 15 has such construction as to facilitate simple and easy re-securing of boot 15 onto leg 18 after a treated area has been attended to or after the injured dog has enjoyed a leg airing out period. Boot 15 is particularly constructed to be readily re-secured to leg 18 because the fixedly anchored straps 14 of boot 15 are positioned in such positions as are determined by the particular dog leg being protected. Hence, when boot 15 is reapplied to dog leg 18 it can be expected that straps 14 when mated to clamp sleeve 12 a second or Nth time onto leg 18 will be in position so as to not cause discomfort to the dog. Because the actual dimensions of dog leg 18 have previously guided the positioning of straps 14 onto sleeve 12 the straps 14 can be expected to be in areas wherein mating of the straps 14 to clamp sleeve 12 onto leg 18 facilitates tight securing of the sleeve onto leg 18 without irritation or discomfort to the dog being cared for. Because the actual dimensions of the dog leg being protected have guided the original positions and orientations of straps 14, straps 14 can be expected to be positioned such that when they are mated they do not clause clamping of an undesired area of a leg such as a joint (e.g., hind foot or carpal or a wounded or treated area). Further, when boot 15 is reapplied to leg 18, after being removed from leg 18, the proper orientation of boot 15 on leg 18 is known. According to the invention boot 15, when manufacturing is complete, has disposed thereon orientation aids which guide the proper positioning of boot 15 on leg 18 where it is reapplied to leg 18. Specifically, as has been indicated herein, boot 15 can contain anti-skid pad 20 which is secured at a particular position on sleeve 12; namely at a location under paw 106. Thus, when reapplying boot 15 to leg 18 a user can rotationally orient sleeve 12 during the application process so that anti-slip pad 20 again will be positioned under paw 106 when sleeve 12 is maneuvered so as to substantially fully envelop dog leg 18. As will be discussed further herein, sleeve 12 can contain additional alignment aids such as seams 308 formed in sleeve 12.

Referring now to FIGS. 3-7, sleeve 12 can take on a variety of different forms and can be manufactured according to a variety of different manufacturing processes.

Referring to FIG. 3, an assembly view of a sleeve according to the invention in one embodiment is shown wherein sleeve 12 is of two part construction. In the embodiment of FIG. 3, sleeve 12 includes first sleeve section 302 and second sleeve section 304 which can be substantially identical in size. Sleeve section 302 and sleeve section 304 can be assembled together utilizing a variety of manufacturing processes. Sleeve section 302 and sleeve section 304 can be polymeric. The sections 302 and 304 can be attached together by heat sealing including by any one of thermal sealing, impulse sealing, dielectric sealing, or by ultrasonic sealing. For thermal sealing, heat is applied by dies or rotating wheels maintained at a constant temperature. For impulse sealing, heat is applied by resistance elements which are applied to the sections when relatively cool, then rapidly heated. For dielectric sealing, radio active waves are applied to induce heat in the sections. For ultrasonic sealing, ultrasonic waves are applied to induce heat in the sections. Where sections 302 and section 304 are non polymeric based, i.e., are cotton fabric based, sections 302 and 304 can be sewn or glued together. As will be described herein, it may be beneficial in some embodiments to make sleeve 12 utilizing breathable material such as cotton fabric or fibrous polyethylene (e.g., TYVEK) so that air can readily enter into the interior of sleeve 12 and thereafter circulate within sleeve 12 and/or so that vapor can readily escape from interior of sleeve 12.

Referring to further aspects of the invention illustrated in FIG. 3 the blown up section 306, of FIG. 3 illustrates that microloops 64, in one illustrated embodiment, can be disposed substantially throughout an entire area of outer surface 32 of sleeve 12. Microloops 64 formed on outer surface 32 of sleeve 12 can be provided in addition to or as a substitute for the microloops 64 that can be formed on anchor end 52 in the position of microhooks 62 shown in FIG. 1, in an alternate embodiment described in connection with FIG. 2f wherein anchor end 52 includes microloops 64, and distal end 54 includes microhooks 62. Constructing sleeve 12 so that microloops 64 are disposed substantially throughout an entire area of outer surface 32 of sleeve 12 substantially increases the ease with which strap 14 can be clamped about sleeve 12 to secure sleeve 12 to a dog leg 18. For example, if the microhooks 62 of distal end 54 of strap 14, as shown in FIG. 2f, are slightly misaligned with the mating microloops 64 at anchor end 52 the microhooks 62 nevertheless engage and mate with the microloops 64 disposed on outer surface 32 of sleeve 12. In a further aspect of the microloops disposed on sleeve outer surface 32, the outer surface disposed microloops 64 preferably are disposed in such a manner so as not to interfere or substantially reduce the securing forces supplied by the adhesive 58 of anchor end 52 which operate to anchor strap 14 firmly and securely onto outer surface 32 of sleeve 12, such that strap 14 is not detached from sleeve 12 with a moderate pulling force supplied by a human of average strength. Microhook microfasteners can be disposed throughout an area of outer surface 32 rather than microloop microfasteners.

In one embodiment, substantially an entire area of outer surface 32 of sleeve 12 has microfasteners, microhooks or microloops disposed thereon operationally disposed to define a surface adapted to engage the microfasteners of a strap distal end 54. In another embodiment, about 75% of the area of outer surface 32 has microfasteners disposed thereon, and 25% of the area is microfastener free, wherein the microfasteners are operationally disposed to define a surface adapted to engage the microfasteners of a strap distal end 54. In another embodiment, about 50% of the area of outer surface 32 has microfasteners distributed thereon and about 50% of the area is microfastener free, wherein the microfasteners are operationally disposed to define a surface adapted to engage the microfasteners of a strap distal end 54. Sleeve 12 can be provided by appropriately cut sections of stock 54″ wide VELCRO brand Wide Loop 3001 (white or black), which is sold by the yard. A sleeve 12 having an entire outer surface defined by VELCRO brand Wide Loop 3001 (white or black) sheet sections can be regarded as a sleeve comprising substantially an entire outer surface having microfasteners disposed therein. Such a sleeve having an entire outer surface defined by VELCRO brand Wide Loop 3001 (white or black) sheet sections can also be regarded as a sleeve comprising a layer, wherein the layer has integrally formed microfasteners.

Referring now to the view of FIG. 4, an assembled sleeve 12 is shown having two sleeve sections, namely, sleeve section 302 and sleeve section 304. It is seen with reference to FIG. 4 that when sleeve 12 has two sleeve sections 302 and 304, seams 308 can be formed on sleeve 12 which extend lengthwise throughout a length of sleeve 12. In an aspect of the invention seams 308 operate to aid the rotational alignment of sleeve 12 when sleeve 12 is applied to a dog leg 18 after a first application of sleeve 12 to dog leg 18. It is preferred that sleeve 12 is rotated into such position that seams 308 oppose the lateral sides of a dog leg 18 and do not oppose the front and a back of a dog leg. Where sleeve 12 is applied to a dog leg in such manner that seams 308 appose the lateral sides of a dog leg and not the front or back of a dog leg, seams 308 do not interfere with the normal hinging of a dog joint, e.g., at carpals 108. Referring to instruction manual 16 (FIG. 1), instruction manual 16 can include instructions 17 advising a user that seams 308 are to be positioned opposite lateral sides of a dog leg 18. Because sleeve 12 is applied in such a manner that seams 308 are positioned opposite lateral sides of a dog leg, the seams 308 provide an orientation aid for aiding the alignment of sleeve 12. Seams 308 guide the rotational alignment of sleeve 12 on a dog leg 18 each time that sleeve 12 (e.g., during a second application where sleeve 12 is part of a completed dog boot 15) is applied to a dog leg 18 in that by aligning seams 308 with lateral sides of a dog leg 18 when sleeve 12 is applied to a dog leg 18, a user is provided with assurance that straps 14 will be positioned in their proper orientations so as not to apply an unwanted clamping force to a joint of a wound on a dog leg 18.

Referring now to FIGS. 5, 6, 7, 8, 9, and 10 embodiments of sleeves according to the invention having more than one layer are shown and described (sleeve 12 in FIG. 1 is a generic sleeve which can have one of more than one layer). Referring to FIG. 5, sleeve 12 has two layers, namely first inner layer 602 and second outer layer 604. First inner layer 602 and second outer layer 604 can have a variety of different compositions. For example, first layer 602 can comprise non-fibrous polyethylene and second layer 604 can comprise smooth latex. In another embodiment first layer 602 comprises “smooth latex” and second layer 604 comprises “coarse latex.” The term “coarse latex” herein refers to latex having particles embedded therein such as sand, grit, stones, etc. so that when the latex dries it is more rugged and damage resistant than if made without the particles. In another embodiment inner layer 602 can comprise breathable fabric and second layer 604 can comprise of latex, either smooth or coarse. In another embodiment first layer 602 can comprise breathable fabric and second layer 604 can comprise smooth or coarse latex. In still another embodiment, first layer 602 can comprise fibrous polyethylene and second layer 604 can comprise smooth or coarse latex.

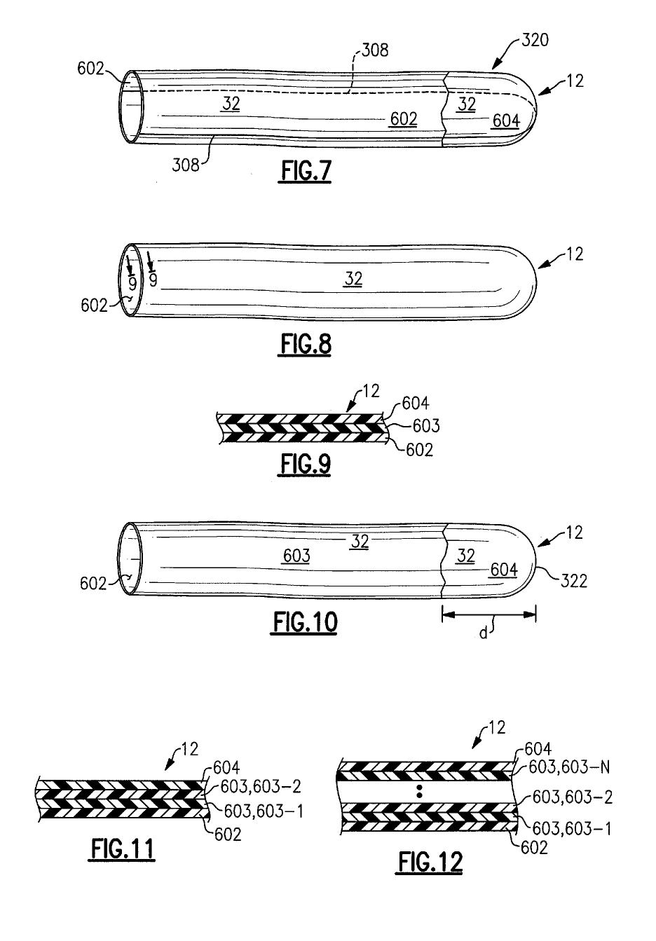

In one illustrative embodiment, a multi-layer sleeve as shown in FIGS. 5-10 can be manufactured utilizing a dipping process, such as a latex dipping process. In a latex dipping process, a vat or other container of liquid latex is provided. A mold shaped in the form of a desired finished product is dipped in the container and then removed and dried. The mold used in the dipping process can be part of the finished product or else the mold used in the dipping process can be removed and separated from the latex part which becomes the finished product, and which is sold or otherwise provided to a user in a form apart from the mold. Latex dipping machinery and technical assistance is available from a variety of sources; for example Green Brook Automations, Ltd. of Chesterfield, UK. Latex dipping services are provided by a variety of sources such as Polytech Synergies LLC of Canal Fulton, Ohio. Latex dipping services are also offered by Minor Rubber Company of Bloomfield, N.J., Latex Products of Mid-State Enterprise of Hawthorne, N.J. and Kent Elastic Products, Inc. of Kent, Ohio. In the view of FIG. 5 an embodiment of sleeve 12 is shown wherein first inner layer 602 is coextensive with second layer 604 such that outer layer 604 extends the full length of inner layer 602. In the illustrative embodiment of FIG. 7, an embodiment of sleeve 12 is shown wherein second layer 604 does not extend the full length of sleeve 12; but rather terminates at a distance d from distal end point 322, wherein d is less than the length of first inner layer 602. First layer 602 can have a length of, e.g., thirty inches and second layer 604 can extend a distance of, e.g., six inches from distal end point 322. Latex dipping can be used to add latex layers to sleeve 12, whether the sleeve has one latex layer, two layers as shown in FIGS. 5-7, three layers as shown in FIGS. 8-10, or more than three layers.

The inventor discovered that it is beneficial to manufacture sleeve 12 so that distal end 320 of sleeve 12 is more rugged, tear resistant and damage resistant than a remainder of sleeve 12. The inventor noted that distal end 320, in general, will encounter stronger and more prevalent forces during use by a dog than the remaining portions of the sleeve. For example when a dog walks, a portion of distal end 320 will be continuously and repeatedly compressed against the ground by a dog's paw.

In one particularly useful embodiment of the invention in accordance with FIG. 7 having a second layer 604 extend only partially the length of inner layer 602, inner layer 602 is provided by breathable fabric, e.g., cotton or water resistant breathable fibrous polyethylene and partially extending outer layer 604 is provided by latex which is coated over breathable fabric layer 602 with use of a dipping process. The latex outer layer 604 can comprise smooth latex or coarse latex, the coarse latex layer being especially desirable where particularly strong forces are expected to be encountered during use. First inner layer 602 can be seamless or have seams 308 as indicated in FIG. 7. The additional protecting function provided by a multi-layer distal end 320 of sleeve 12 can be a substitute or else in addition to a protecting function provided by anti-skid pad 20 as described previously herein.

Embodiments of sleeve 12 having three layers are shown and described in connection with FIGS. 8, 9, and 10. In FIG. 8 the prospective view of the three layer sleeve 12 is shown having an inner layer 602, outer layer 604, and an intermediate layer 603, which is hidden from the view of FIG. 8. In FIG. 9 a cross-sectional view of the sleeve 12 shown in FIG. 8 is shown. Intermediate layer 603 is visible in the view of FIG. 9. With reference to the cross-sectional view of FIG. 9, sleeve 12 includes an intermediate layer 603 disposed intermediate of inner layer 602 and outer layer 604. In the view of FIG. 10 an alternative embodiment of a three layer sleeve 12 is shown. Sleeve 12 of FIG. 10 includes an inner layer 602, an outer layer 604 and an intermediate layer 603. Outer layer 604 extends only a distance “d” upward on sleeve 12, where “d” is less than the total length of sleeve 12. Outer layer 604 in the embodiment shown in FIG. 10 can be provided by latex dipping of the layer. In the embodiments of FIGS. 5 and 8 outer surface 32 of sleeve 12 is defined entirely by outer layer 604 of sleeve 12. In the embodiment of FIGS. 7 and 10 having partially extending the outer layer 604, the outer surface 32 of sleeve 12 is partially defined by a layer other than outer layer 604. In the two layer embodiment of FIG. 7, outer surface 32 is partially defined by inner layer 602 and partially defined by outer layer 604. In the three layer embodiment of FIG. 10 outer surface 32 is partially defined by intermediate layer 603 and outer layer 604. Where sleeve 12 has a single layer; namely, inner layer 602, outer surface 32 is defined by inner layer 602.

Sleeve 12 according to the invention can have more than one intermediate layer 603. In the embodiment of FIG. 11 the cross-sectional view of an embodiment of sleeve 12 is shown having two intermediate layers; namely intermediate layer 603-1 and intermediate layer 603-2. In the alternative embodiment of sleeve 12 shown in FIG. 12, the cross-sectional view of sleeve 12 is shown having N intermediate layers 603; namely intermediate layers 603-1, intermediate layer 603-2, and intermediate layer 603-N. Referring to Table B herein below, several alternative embodiments of sleeve 12 according to the invention are summarized.

TABLE B

| Embodiment | Inner Layer 602 | Intermediate Layer 603 | Outer Layer 604 | Manufacturing Detail |
|---|---|---|---|---|
| 1 | Non-Fibrous | This embodiment has a | This embodiment has a | Edges of sections are heat |
| | Polyethylene in first and | single layer | single layer | sealed. |
| | second sections | | | |
| 2 | Microloop sheets in first | This embodiment has a | This embodiment has a | Edges of sections are heat |
| | and second sections. | single layer | single layer | sealed. |
| | (Sections cut from | | | |
| | VELCRO ® white or | | | |
| | black wide loop 3001 | | | |
| | sheets) | | | |
| 3 | Non-Fibrous | This embodiment has a | Smooth Latex | Outer layer extends 6″ from |
| | Polyethylene in first and | single layer | | distal endpoint. Outer layer |
| | second sections | | | formed by latex dipping over |
| | | | | inner layer 602 |
| 4 | Smooth Latex | This embodiment has a | This embodiment has a | Single layer formed by latex |
| | | single layer | single layer. | dipping using removable |
| | | | | dipping mold. |
| 5 | Smooth Latex | This embodiment has | Coarse Latex | Outer layer extends only 6″ |
| | | only two layers | | from distal endpoint, formed |
| | | | | by latex dipping |
| 6 | Breathable Porous | This embodiment has | Coarse Latex | Outer layer extends only 6″ |
| | Fabric (e.g. Cotton) in | only two layers | | from distal endpoint. Outer |
| | first and second sections | | | layer formed by latex dipping. |
| | | | | Breathable fabric inner layer |
| | | | | formed by stitching or gluing |
| | | | | together two sleeve sections. |
| 7 | Breathable Porous | This embodiment has | Smooth Latex | Outer layer extends only 6″ |
| | Fabric (e.g. Cotton) in | only two layers | | from distal endpoint. Outer |
| | first and second sections | | | layer formed by latex dipping. |
| | | | | Breathable fabric inner layer |
| | | | | formed by stitching or gluing |
| | | | | together two sleeve sections. |
| 8 | Breathable Porous | This embodiment has | Latex (Smooth or | Outer layer extends full length |
| | Fabric (e.g. Cotton) in | only two layers | Coarse) | of sleeve. Outer layer formed |
| | first and second sections | | | by latex dipping over the first |
| | | | | layer. Breathable fabric inner |
| | | | | layer formed by stitching or |
| | | | | gluing together two sleeve |
| | | | | sections. |
| 9 | Microloop sheets in first | This embodiment has | Latex (Smooth or | Edges of top and bottom |
| | and second sections. | only two layers | Coarse) | sleeve sections are heat sealed. |
| | (Sections cut from | | | Outer layer extends only 6″ |
| | VELCRO ® white or | | | from distal end point. Outer |
| | black wide loop 3001 | | | layer formed by latex dipping. |
| | sheets) | | | |
| 10 | Fibrous Polyethylene | This embodiment has | Latex (Smooth or | Sections of fibrous |
| | (Tyvek Type 14 or Type | only two layers | Coarse) | polyethylene are stitched |
| | 16) in first and second | | | together or glued. Outer layer |
| | sections | | | extends only 6″ from distal |
| | | | | endpoint. Outer layer formed |
| | | | | by latex dipping |
| 11 | Breathable Porous | Fibrous Polyethylene (Tyvek | Latex (Smooth or | Sections of breathable fabric |
| | Fabric (e.g. Cotton) in | Type 14 or Type 16) in first | Coarse) | and sections of fibrous |
| | first and second sections | and second sections | | polyethylene are stitched |
| | | | | together or glued. Outer layer |
| | | | | extends only 6″ from distal |
| | | | | endpoint. Outer layer formed |
| | | | | by latex dipping. |
| 12 | Breathable Porous | Smooth Latex | Coarse Latex | Sections of breathable fabric |
| | Fabric (e.g. Cotton) in | | | inner layer are stitched |
| | first and second sections | | | together or glued together. |
| | | | | Intermediate and outer layers |
| | | | | formed by latex dipping. Outer |
| | | | | layer extends only 6″ from |
| | | | | distal end point |

(All sleeves have total length of thirty inches)

Embodiment one (1) is a single layer sleeve having a single non-fibrous polyethylene layer, provided in sections that are heat sealed together. Non- fibrous polyethylene is generally water resistant and air-tight (non-breathable). Embodiment two (2) is a single layer sleeve manufactured as described in connection with FIG. 3 wherein a pair of microloop sheets are provided and heat sealed about their respective peripheral edges. Embodiment three (3) is a two layer sleeve including a first inner polyethylene layer and a second smooth latex layer extending partially the length of the inner layer. Embodiment four (4) is a single layer sleeve including a single layer comprising smooth latex. Embodiment four may be manufactured utilizing a latex dipping process wherein a removable mold is deployed during dipping and removed after drying so that a finished product is provided comprising a single layer of smooth latex. Embodiment five (5) is a two layer sleeve including a first inner layer of smooth latex and a second outer layer of coarse latex extending partially the length of the inner layer. Embodiment six (6) comprises a first breathable fabric layer and a second coarse latex layer extending only a portion of the total length of the inner layer. Embodiment seven (7) is a two layer sleeve including a first breathable fabric layer and a second smooth latex layer extending only a portion of the total length of the first breathable fabric layer. Embodiment eight (8) is a two layer sleeve including a first inner breathable fabric layer and a second latex layer (smooth or coarse) extending the full length of the first breathable fabric layer.

Embodiment nine (9) is a two layer sleeve including an inner layer comprising microloop sheets in first and second sections and a second layer and an outer layer comprising latex (smooth or coarse). The first and second sections of sleeve 12 in embodiment nine (9) can be attached together by heat sealing or by gluing. The latex outer layer 604 can be formed on the inner layer by way of latex dipping. The outer layer 604 in the ninth embodiment extends only six inches from a distal end point 322 of sleeve 12. Embodiment 10 is a two layer sleeve including a first inner layer 602 comprising fibrous polyethylene provided in first and second sections and an outer layer 604 comprising latex (smooth or coarse) formed by latex dipping the layer onto the inner layer 602. The sections of fibrous polyethylene forming inner layer 602 can be stitched or glued together. The outer layer 604 extends only six inches from the distal end point and does not extend the full length of sleeve 12 which as shown in Table A can include a length of about thirty inches. Embodiment 11 is a three layer sleeve including a first inner layer 602 comprising breathable fabric (e.g., cotton) in first and second sections, an outer layer 604 comprising latex (smooth or coarse) formed by latex dipping onto intermediate layer 603, and intermediate layer 603 comprising fibrous polyethylene in first and second sections. The sections of the breathable fabric layer and the fibrous polyethylene layer can be stitched together or glued together. Outer layer 604 extends only six inches from distal end point 622. Embodiment twelve (12) is a three layer sleeve including an inner layer 602 comprising breathable fabric (e.g., cotton) in first and second sections, an outer layer 604 comprising coarse latex, and an intermediate layer 603 comprising smooth latex in first and second sections. The sections of the breathable fabric inner layer can be stitched or glued together. The intermediate layer 603 and outer layer 604 can be formed on the sleeve by latex dipping. Intermediate layer 603 comprising smooth latex can extend the full length of sleeve 12 while outer layer 604 in the twelfth embodiment extends only partially the length of sleeve 12, e.g., six inches, from the distal end point 322. Referring to embodiments ten (10) and eleven (11), including layers comprising fibrous polyethylene the inclusion of layers comprising fibrous polyethylene provides significant advantages. Fibrous polyethylene such as may be provided by TYVEK Type 14 or Type 16 sheets, is both water resistant and breathable so that water or other liquid cannot readily enter an interior of sleeve 12 from an exterior of sleeve 12 and further so that water vapor (e.g., as may be formed by perspiration) is allowed to escape from an interior of sleeve 12 to an exterior of sleeve 12. Thus, embodiments of the invention including fibrous polyethylene sleeve layers and being devoid of water and air tight sleeve layers extending the full length of sleeve 12 are comprehensively water resistant to allow dogs to walk in water and yet are breathable to allow perspiration to escape from a dog leg 18 from sleeve 12 to substantially increase the comfort of a dog. TYVEK is available from E. I. duPont deNemours and Company.

Referring to embodiments eleven and twelve, the embodiments in eleven and twelve include an inner layer 602 comprising breathable porous fabric (e.g., cotton) forming sleeve 12 so that inner layer 602 including breathable porous fabric (e.g., cotton) having pores sized to engage fur of a dog leg enhances the ease with which sleeve 12 is secured to a dog leg 18. The inventor discovered that fur of a dog leg 18 tends to slightly penetrate the surface of inner layer 602 when provided by porous fabric so that sleeve 12 is easily oriented in a stable position on leg 18 prior to the anchoring of straps 14. By contrast, when inner layer 602 is provided by water and air tight non-fibrous polyethylene sleeve 12 tends to slip rotationally and up and down on dog leg 18 during the sleeve securing process (which may be desirable in certain use cases). The providing of an inner layer 602 comprising porous fabric having pores sized to engage fur of a dog leg tends to result in sleeve 12 being more easily positioned on a dog leg 18 during the sleeve securing process. The presence of a porous breathable fabric inner layer 602 has also been observed to enhance the capacity of sleeve 12 to remain in a stable position on dog leg 18 after it is secured to a dog leg 18 by the mating of straps 14 to clamp sleeve 12 about a dog leg 18. Porous fabric can be provided by cotton sheet sections. Porous layers of material can also be provided by Type 16 TYVEK which has holes distributed therein having diameters of from about 5 mils to about 20 mils that are sufficiently sized to engage dog fur. Type 16 TYVEK also has an air permeability of between about 27 Frazier ft³/ft²-min and 53 Frazier ft³/ft²-min.

While the present invention has necessarily been described with reference to a number of specific embodiments, it will be understood that the time, spirit, and scope of the present invention should be determined only with reference to the following claims:

1. A kit for protecting a leg of a canine, the kit comprising:
(a) a sleeve being of such size to be fitted over a dog leg, the sleeve having an inner surface, an outer surface, a proximal end and a distal end, the proximal end being open to allow insertion of the dog leg, the sleeve being one of single layered or multilayered;
(b) at least one strap having an anchor end and a distal end, the anchor end and the sleeve being configured so that the anchor end can be anchored to the sleeve at any one of a plurality of positions and orientations, the sleeve and the at least one strap being provided in a form such that the sleeve and the at least one strap are separate and apart from one another prior to the sleeve being fitted over the dog leg, the at least one strap being sized to a length that allows the at least one strap to encircle a circumference of the sleeve when fitted over the dog leg, the at least one strap having a distal end configured to detachably engage at least one of the sleeve and the anchor end; and
(c) an instruction manual, the instruction manual being one of carried by a physical substrate and electronically displayed, the instruction manual including at least the instruction that the sleeve and the at least one strap should be maintained in positions that are separate and apart from one another until such time that the sleeve is fitted over the dog leg.

2. The kit of claim 1, wherein the distal end of the at least one strap includes microfasteners, and further wherein both of the outer surface of the sleeve and the anchor end of the at least one strap have microfasteners adapted to detachably engage the microfasteners of the distal end.

3. The kit of claim 1, wherein the outer surface that is at least partially defined by a layer that includes integrally formed microfasteners adapting the sleeve for engagement with the at least one strap.

4. The kit of claim 1, wherein the sleeve is a multilayered sleeve having an inner layer an outer layer and a distal endpoint, the outer layer comprising latex and being formed by latex dipping, the outer layer extending a portion of a length of the sleeve from the distal endpoint.

5. The kit of claim 1, wherein at least one layer of the sleeve includes pores distributed throughout an area of the layer having holes ranging from between about 5 mils and about 20 mils.

6. The kit of claim 1, wherein the sleeve is multilayered and wherein at least one layer of the sleeve comprises material having air permeability of between about 27 Frazier ft.sup.3/ft.sup.2-min, and about 53 Frazier ft.sup.3/ft.sup.2-min.

7. The kit of claim 1, wherein the sleeve comprises the outer layer comprising latex and being formed by latex dipping, the outer layer extending a portion of a length of the sleeve and being formed at the distal end so that that the outer surface of the sleeve is only partially defined by the outer layer and further so that the distal end is more rugged than a remainder of the sleeve, the inner layer comprising material that is selected from the group consisting of (1) porous and breathable fabric, (2) fibrous polymer, and (3) non-fibrous polymer, the sleeve having at least two sleeve sections that are one of glued together, sewn together or fused together by heat sealing.

8. An apparatus for use in protecting a dog leg, the apparatus comprising:
(a) a sleeve, the sleeve having a first portion adapted for covering a paw of a dog leg and a second portion adapted for covering an area of the dog leg above the paw, the sleeve being sized to fit over the dog leg, the sleeve having an inner surface and an outer surface, each of the inner surface and outer surface being partially included on the first portion, each of the inner surface and outer surface being partially included on the second portion; and
(b) a first strap having outer surface, an inner surface, an anchor end, and a distal end, the anchor end of the first strap being adapted for anchoring of the first strap on the sleeve, the first strap having microfasteners disposed on an inner surface of the distal end thereof;
(c) wherein there is disposed throughout substantially an entire area of the outer surface of the second portion microfasteners adapted for engagement with the microfasteners of the first strap;
(d) wherein the sleeve comprises an open proximal end and a closed distal end; and
(e) wherein the sleeve comprises flexible material.

9. The apparatus of claim 8, wherein the first strap is provided in a form detached from the sleeve so that the strap can be anchored onto the sleeve after such time that the sleeve is fitted over the dog leg.

10. The apparatus of claim 8, wherein the apparatus further includes an instruction manual, the instruction manual including at least the instruction to maintain the first and the second strap at such position that is separate and apart from the sleeve until such time that the sleeve is fitted over the dog leg.

11. The apparatus of claim 8, wherein the sleeve includes at least a first layer and a second outer layer, the first layer comprising smooth latex and being formed by latex dipping, the second outer layer comprising coarse latex and being formed by latex dipping, the second layer extending only a portion of a length of the first layer from a distal endpoint of the sleeve, wherein the sleeve further includes an intermediate layer comprising fibrous polyethylene that is breathable and water resistant.

12. The apparatus of claim 8, wherein the microfasteners disposed throughout substantially the entire area of the outer surface of the second portion are integrally formed in the outer surface of the second portion.

13. The apparatus of claim 8, wherein the sleeve includes a certain layer defining the outer surface, the certain layer comprising a sheet of material having integrally formed microfasteners.

14. The apparatus of claim 8, wherein the first portion of the sleeve includes microfasteners disposed substantially throughout an entire area of the outer surface of the first portion.

15. An apparatus for use in protecting a dog leg, the apparatus comprising:
(a) a sleeve having an inner surface and an outer surface, the sleeve being sized to fit over a dog leg, the sleeve being one of single layered or multilayered, the sleeve having a certain layer at least partially defining an outer surface of the sleeve; and
(b) a first strap having outer surface, an inner surface, an anchor end, and a distal end, the anchor end of the first strap being adapted for anchoring of the strap on the sleeve, the strap having microfasteners disposed on an inner surface of the distal end thereof;
(c) wherein the certain layer at least partially defining the outer surface includes integrally formed microfasteners adapted for engagement with the microfasteners of the first strap;
(d) wherein the sleeve comprises an open proximal end and a closed distal end; and
(e) wherein the sleeve comprises flexible material.

16. The apparatus of claim 15, wherein the first strap is provided in a form detached from the sleeve so that the strap can be anchored onto the sleeve after such time that the sleeve is fitted over the dog leg.

17. The apparatus of claim 15, wherein the sleeve includes the certain layer and an outer layer, the outer layer comprising latex and being formed by latex dipping, the outer layer extending only a portion of a length of the certain layer from a distal endpoint of the sleeve.

18. The apparatus of claim 15, wherein the apparatus further includes a second strap and an electronic medium storing a file including a set of instructions viewable with use of a display equipped computer, the set of instructions including at least the instruction to maintain the first and the second strap at such position that is separate and apart from the sleeve until such time that the sleeve is fitted over the dog leg.

19. The apparatus of claim 15, wherein the sleeve includes microfasteners disposed substantially throughout an entire area of the outer surface of the sleeve.

20. The apparatus of claim 15, wherein the sleeve includes a first portion adapted for covering a paw of a dog leg, and a second portion adapted for covering an area of the dog leg above the paw, wherein the inner surface is partially included in each of the first and second portions, and wherein the outer surface is partially included in each of the first and second portions, and wherein the sleeve includes microfasteners disposed substantially throughout an entire area of the outer surface of the second portion.
